(19) United States
(12) Patent Application Publication
(10) Pub. No.: US 2026/0048743 A1
(43) Pub. Date: Feb. 19, 2026

(54) VEHICULAR ADAPTIVE CRUISE CONTROL SYSTEM

(71) Applicant: Magna Electronics Inc., Auburn Hills, MI (US)

(72) Inventors: Tejas Murlidhar Varunjikar, Troy, MI (US); Arpit Awathe, Rochester Hills, MI (US); Dhruv Mathur, Troy, MI (US)

(21) Appl. No.: 19/295,798

(22) Filed: Aug. 11, 2025

Related U.S. Application Data
(60) Provisional application No. 63/682,399, filed on Aug. 13, 2024.

(51) Int. Cl. B60W 30/17; B60W 30/16; B60W 50/00

(52) U.S. Cl. CPC B60W 30/17; B60W 30/162; B60W 50/0097; B60W 50/0098; B60W 2420/403; B60W 2420/408; B60W 2540/215; B60W 2554/4041; B60W 2554/4042; B60W 2554/4045; B60W 2554/802; B60W 2555/60; B60W 2720/103; B60W 2720/106; B60W 2754/30

(57) ABSTRACT

A vehicular driving assist system includes at least one sensor disposed at a vehicle. The sensor includes a forward-viewing camera that views at least forward of the equipped vehicle. The system, responsive to processing of sensor data captured by the at least one sensor, (i) determines a leading vehicle in front of the equipped vehicle and within a traffic lane along which the equipped vehicle is currently traveling and (ii) determines a status of a traffic indicator for the traffic lane along which the equipped vehicle is currently traveling. The system predicts forward movement of the leading vehicle based the status of the traffic indicator. The system controls acceleration of the equipped vehicle based at least in part on the predicted forward movement of the leading vehicle.

### CROSS REFERENCE TO RELATED APPLICATION

The present application claims the filing benefits of U.S. provisional application Ser. No. 63/682,399, filed Aug. 13, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more cameras and/or radar sensors at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driving assist system includes at least one sensor disposed at a vehicle equipped with the vehicular driving assist system. The at least one sensor senses exterior of the equipped vehicle. The at least one sensor at least includes a forward-viewing camera that views at least forward of the equipped vehicle. The at least one sensor is operable to capture sensor data. The system includes an electronic control unit (ECU) with electronic circuitry and associated software. The sensor data captured by the at least one sensor is transferred to the ECU. The electronic circuitry of the ECU includes a data processor for processing sensor data captured by the at least one sensor and transferred to the ECU. The vehicular driving assist system, based at least in part on processing at the ECU of sensor data captured by the at least one sensor, (i) determines a leading vehicle in front of the equipped vehicle and within a traffic lane along which the equipped vehicle is currently traveling and (ii) determines status of a traffic indicator for the traffic lane along which the equipped vehicle is currently traveling. The vehicular driving assist system predicts forward movement of the leading vehicle based at least in part on the status of the traffic indicator. The vehicular driving assist system controls acceleration of the equipped vehicle based at least in part on the predicted forward movement of the leading vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a driving assist system that incorporates sensors; and

FIG. 2 is a schematic view of an adaptive cruise control algorithm.

### DESCRIPTION OF THE PREFERRED EMBODIMENTS

A vehicle sensing system and/or driver or driving assist system operates to capture data representative of the exterior of the vehicle and may process the captured data to detect objects at or near the vehicle and in the area of the vehicle, such as to assist a driver of the vehicle in maneuvering the vehicle in a forward or rearward direction. The driving assist system includes a processor or processing system that is operable to receive sensor data from one or more sensors (e.g., radar sensors, lidar sensors, ultrasonic sensors, imaging sensors, etc.).

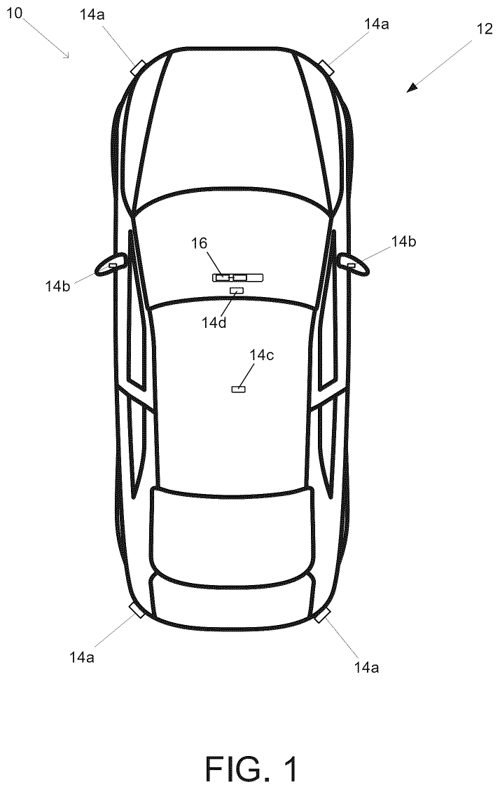

Referring now to the drawings and the illustrative embodiments depicted therein, a vehicle 10 (FIG. 1) includes a driving assistance system 12 that includes at least one exterior viewing sensor, such as one or more radar sensors 14a, cameras 14b, lidar sensors 14c, ultrasonic sensors, and/or any other imaging or non-imaging sensor(s). Each sensor 14a-c may be disposed at, for example, one or both exterior side mirrors of the vehicle, at one or more corners of the vehicle (e.g., at a corner of a bumper), at a windshield of the vehicle, and/or at a rooftop of the vehicle. The sensor(s) capture sensor data representative of the scene occurring exterior of the vehicle (e.g., at least forward and/or rearward of the vehicle). The sensors may include a forward-viewing camera or front camera module (FCM) 14d disposed at a windshield of the vehicle and viewing forward of the vehicle through the windshield. The driving assistance system 12 includes a control or electronic control unit (ECU) 16 having electronic circuitry and associated software, with the electronic circuitry including a data processor or image processor that is operable to processor sensor data captured by the sensors, whereby the vehicular driving assist system or ECU may detect or determine presence of objects or the like and alert an occupant of the vehicle and/or control movement of the vehicle. The data transfer or signal communication from the camera to the ECU may comprise any suitable data or communication link, such as a vehicle network bus or the like of the equipped vehicle.

Advanced driver assistance system (ADAS) features like adaptive cruise control (ACC) have been around for more than two decades. Adaptive cruise control is a vehicle software feature that helps the driver maintain longitudinal control of the vehicle by maintaining a vehicle speed set by the driver while also slowing down or speeding up based on the presence of other vehicles (i.e., target or leading vehicles) in the path of the equipped vehicle. Typically, the driver selects a gap to be maintained between the equipped vehicle and other vehicles in the path of the equipped vehicle. For example, the driver may select a gap of ten feet such that the ACC system of the equipped vehicle maintains at least ten feet behind another vehicle. In other examples, the driver selects an amount of time (e.g., 2 seconds, 3 seconds, etc.) and the system maintains a sufficient distance between vehicles such that the equipped vehicle, when traveling at the current speed, will take at least the selected amount of time to reach the position of the leading vehicle. The ACC system may instruct the vehicle to decelerate below the speed set by the driver in order to maintain the selected gap (i.e., will slow the vehicle to match the speed of the leading vehicle). Moreover, acceleration and deceleration profiles may be calibrated by the driver based on in-vehicle comfort metrics. For example, a non-aggressive in-vehicle comfort metric may restrict the ACC system from accelerating or decelerating the vehicle above a particular threshold (e.g., a maximum acceleration/deceleration in m/s²). On the other hand, an aggressive in-vehicle comfort metric may enable the ACC system to accelerate or decelerate the vehicle above the particular threshold.

Implementations herein are directed towards modifying the acceleration and/or deceleration of the equipped vehicle using environmental information in addition to or alternative to the motion of the target vehicle, thereby providing a more human-like or comfortable driving experience. Many driving assist systems, such as adaptive cruise control systems, operate reactively based primarily on a detected distance to and a current velocity of a leading vehicle. This may result in abrupt or inefficient vehicle control, as the system lacks context for the leading vehicle's actions. For example, such a system may not differentiate between a leading vehicle slowing for a temporary obstruction and a leading vehicle slowing to stop for a red traffic light, potentially leading to inefficient deceleration profiles. The vehicular driving assist system described herein, in some examples, addresses these scenarios by having an ECU or other control process sensor data to determine not only a leading vehicle but also a status of a relevant traffic indicator. By correlating the status of the traffic indicator with the behavior of the leading vehicle, the system may predict forward movement and/or a future velocity of that leading vehicle. For instance, the system may predict that a leading vehicle approaching a red traffic light will decelerate to a stop, or that a leading vehicle stopped at a red traffic light that transitions to green will accelerate. Responsive to this prediction of the movement/future velocity, the vehicular driving assist system adjusts a velocity profile, such as a maximum acceleration or deceleration rate, for the equipped vehicle. The system then controls the acceleration of the equipped vehicle based on this adjusted, context-aware velocity profile. This approach enables the system to initiate deceleration earlier and more gradually when approaching a stopping lead vehicle at a red light, or to accelerate more confidently when a lead vehicle proceeds through a newly green light. Such operation may result in smoother vehicle control, improved energy efficiency, and a more comfortable and intuitive experience for occupants of the equipped vehicle.

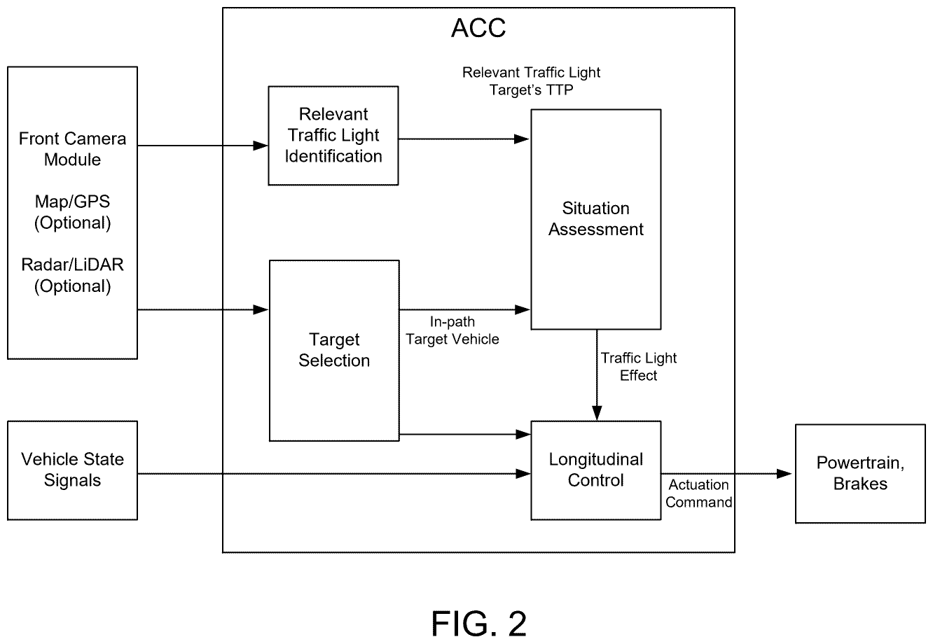

Referring now to FIG. 2, the sensors equipped at the vehicle may include one or more cameras (e.g., the front camera module (FCM)), one or more radar sensors, a lidar sensor, and/or a global positioning (GPS) sensor. The ECU is communicatively coupled to these sensors to receive and process the captured sensor data. The front camera module may include a camera-based perception sensor that captures information such as other vehicles, traffic signs, traffic lights, lane markers, road edges, etc. The FCM includes an exterior viewing imaging sensor or camera, such as a forward viewing imaging sensor or camera, which may be disposed at and behind the windshield of the vehicle and viewing forward through the windshield so as to capture image data representative of the scene occurring forward of the vehicle. In some implementations, the ECU processes this image data to identify a traffic indicator, such as a traffic light, within the forward field of view and to determine a status of that traffic indicator by, for example, identifying a location and color of an illuminated portion of the identified traffic indicator.

Radar sensors use radio waves to detect and determine the position of various objects in the environment surrounding the equipped vehicle, such as, for example, other vehicles, pedestrians, and small structures (e.g., traffic lights, traffic signs, etc.). In some examples, the radar sensors include at least one radar sensor unit, such as a forward facing radar sensor unit or a corner radar sensor unit (and the system may optionally include multiple exterior facing sensors, such as cameras, radar, or other sensors, such as a rearward sensing sensor at the rear of the vehicle, and a sideward/rearward sensing sensor at respective sides of the vehicle), which sense regions exterior of the vehicle. Similarly, lidar sensors use lidar scans to capture the various objects in the environment surrounding the equipped vehicle. Both radar and lidar sensors are effective at determining a precise longitudinal distance, a relative velocity, and a position of other vehicles, including a leading vehicle in the same traffic lane as the equipped vehicle. The data from these sensors may be processed by the ECU to track the leading vehicle over time. The use of multiple sensor modalities, such as combining image data from the camera with radar data from the radar sensor, may provide for a more reliable and accurate determination of the leading vehicle's position and motion.

The GPS sensor may provide a standard definition (SD) map or high definition (HD) map of the environment surrounding the equipped vehicle. These maps may include stored information regarding lane markers, traffic light locations, etc. This map data may be used by the ECU to anticipate the location of an upcoming traffic indicator, allowing the system to focus processing of sensor data from the forward-viewing camera on a specific region of interest to more efficiently detect the traffic indicator and its status. Moreover, advanced maps with vehicle-to-infrastructure capabilities may enable the GPS sensor to communicate with certain infrastructure components. For example, a traffic light may communicate to the GPS sensor a status (e.g., red, yellow, green) of the traffic light. This communication may indicate a future status of the traffic indicator, such as a time remaining until a current green light status transitions to a yellow light status. The ECU may receive this communication and use the indicated current status or the future status of the traffic indicator in its processing. The maps may be stored at memory hardware disposed at the vehicle. Alternatively, the maps may be retrieved via wireless or wired communication with a remote server (e.g., via the Internet) or a user device.

In some implementations, the sensors equipped at the vehicle provide vehicle state information to the vehicle. For example, an inertial measurement unit (IMU) sensor, wheel speed sensors, etc., output sensor data indicating yaw rate, vehicle speed (e.g., velocity), vehicle acceleration or deceleration, vehicle gear state, user human machine interface (HMI) inputs, etc. The ECU may process this sensor data to reduce noise and enhance signal quality. The ECU may use this vehicle state information, such as the current velocity of the equipped vehicle, as a baseline for determining how to adjust a velocity profile and for generating control signals for the vehicle's propulsion and braking systems.

The ACC system may use sensor data from any of the sensors (e.g., image data captured by the FCM and/or map information and/or sensor data captured by the radar/lidar sensors) to perform relevant traffic light detection. In particular, the ACC system may include a traffic light identification module that calculates the location and status of relevant traffic lights. For example, the status of a traffic light may include a red light status, a yellow light status, or a green light status. When vehicle-to-infrastructure capability is available, the traffic lights may communicate a status and/or a future status of the traffic lights to the vehicle (e.g., via wireless communication). Here, the communicated status may indicate the current status of the traffic light and/or a time until the next status of the traffic light will occur. For example, the traffic light may communicate that the current status of the light is green and that the traffic light will change to a yellow light status in 10 seconds. The ACC system may control the engine and/or transmission and/or propulsion system and/or brake system of the vehicle to adjust or control speed, acceleration, and/or deceleration of the vehicle based on the current status and/or the future status of the traffic lights. This proactive information regarding a future status allows the system to predict a movement or future velocity of a leading vehicle with greater confidence and to adjust the equipped vehicle's velocity profile preemptively, rather than reacting only after the leading vehicle has changed its speed.

Optionally, the ACC system includes a target selection module. The target selection module performs target selection to detect a target object or target objects in the environment surrounding the equipped vehicle. That is, by processing sensor data from the imaging sensor, the radar sensor, the lidar sensor, and/or any other available sensors, along with a combination of vehicle state signals, a relevant target vehicle or target vehicles that are in the path of the equipped vehicle are identified (e.g., a leading vehicle). This process may involve sensor fusion, where the ECU correlates data from multiple sensors to confirm the presence and characteristics of a detected object. For example, the ECU 16 may fuse object data from the forward-viewing camera with range and velocity data from a forward-sensing radar sensor to robustly identify and track a vehicle. The target selection module determines that a tracked vehicle is the leading vehicle by determining that the vehicle is located in front of the equipped vehicle and, based on lane marker data from the camera or map data, is within the same traffic lane along which the equipped vehicle is currently traveling. The ACC system may control speed, acceleration, and/or deceleration of the vehicle based on the target object(s). For example, the ACC system adjusts a speed of the vehicle to match the speed of the leading vehicle while maintaining a selected gap.

The ACC system includes a situation assessment module. Based on the relevant traffic light detection and the target selection, the situation assessment determines whether a decelerating target vehicle is taking action due to an approaching red or yellow traffic light. This determination may be made by correlating in time the deceleration of the leading vehicle with the detection of the red or yellow status of the traffic indicator. For example, if the leading vehicle begins to decelerate at a location consistent with stopping for a traffic light that the system has identified as red, the module may determine with high confidence that the traffic light is the cause. In this scenario, the situation assessment module may differentiate between a vehicle slowing down temporarily (e.g., due to an object crossing the road) and a vehicle slowing down to stop for a period of time (e.g., due to a red traffic light). Similarly, when a target vehicle begins accelerating from lower speeds to higher speeds, the situation assessment module may determine whether this is due to a traffic light changing from red to green. Here, the traffic assessment module is able to differentiate between a vehicle accelerating to simply pull forward a short distance (e.g., a few feet) at a red traffic light and a vehicle accelerating through a traffic light due to the traffic light turning from red to green. In short, the situation assessment module may determine or predict a movement or future velocity of another vehicle based on a status of the traffic indicator. This traffic light information may be calculated as either a binary output or a probabilistic output (i.e., a likelihood or a confidence output). This binary output or probabilistic output is referred to herein as a traffic light effect. The traffic light effect thus quantifies the system's assessment that the observed or anticipated action of the leading vehicle is a direct result of the traffic indicator's status.

A longitudinal control module may control the longitudinal motion of the vehicle using the situation assessment module, information related to any detected vehicles or objects in the path of the equipped vehicle, and the vehicle state signals. Controlling the longitudinal motion or forward motion of the vehicle may include determining an actuation command to maintain a desired velocity (e.g., speed) profile of the vehicle. This output may be a propulsion control command that controls a propulsion system of the vehicle, such as an acceleration command (e.g., with positive, zero, or negative values), or the output may be a braking command, or a combination of acceleration and braking commands or an equivalent form. The in-path target vehicle's information (i.e., lateral distance, longitudinal distance, longitudinal velocity, etc.) along with vehicle state of the equipped vehicle (e.g., velocity, acceleration, deceleration, etc.) are used to determine the actuation command. Moreover, the longitudinal control module may alter the velocity profile (i.e., acceleration, deceleration, or maintaining a desired velocity) based on the traffic light effect. Specifically, responsive to the prediction of the movement or future velocity of the leading vehicle (which is informed by the traffic light effect), the longitudinal control module adjusts the velocity profile of the equipped vehicle. In other words, the actuation commands may be based on the output of the situation assessment module.

For example, if the equipped vehicle normally starts slowing down for a stopped target vehicle from a certain distance away, the equipped vehicle may do so from a farther distance now if the traffic light effect is above a threshold value (e.g., a probability or confidence of the traffic light effect is above the threshold value). That is, the equipped vehicle may typically start slowing down when the equipped vehicle is fifty feet away from another vehicle and, in contrast, the equipped vehicle may start slowing down one hundred feet away from another vehicle when the traffic light is red or is transitioning from green or yellow to red (i.e., based on the traffic light effect). This adjustment represents a change to the deceleration profile, a component of the overall velocity profile, which may be triggered by the prediction that the leading vehicle will remain stopped for an extended period.

On the other hand, if the equipped vehicle typically accelerates slowly to help with stop and go traffic situations, the equipped vehicle may choose to accelerate quicker if the traffic light effect indicates that an in-path target vehicle is accelerating in reaction to a traffic light changing from red to green. That is, the equipped vehicle may normally accelerate at a first acceleration rate when another vehicle starts to move to maintain a safe distance from the other vehicle in case the other vehicle stops or slows down shortly after starting to move. However, when the situation assessment indicates that the traffic light is green or has recently transitioned from red to green, the vehicle may accelerate at a second acceleration rate greater than the first acceleration rate because the equipped vehicle may infer that the other vehicle is not going to slow down or stop shortly after starting due to the green traffic light. In this case, the system adjusts the velocity profile by increasing a maximum acceleration parameter, allowing for more assertive and efficient acceleration when the context provided by the traffic light status makes such an action appropriate.

Notably, the vehicular ADAS uses sensor data from imaging sensors, radar sensors, and/or lidar sensors to control the longitudinal motion of the equipped vehicle and uses sensor data from the imaging sensors or map information to calculate a traffic light effect affecting the longitudinal motion control of the equipped vehicle. In particular, the vehicular ADAS or driving assist system uses the imaging sensors and/or the map to determine the presence (if any) and status of a traffic light and its relevance to the in-path target vehicle (e.g., detected vehicle). The vehicular ADAS performs the situation assessment (e.g., at the situation assessment module) to determine the traffic light effect indicating whether the traffic light presence and status should affect the equipped vehicle's longitudinal motion control. Moreover, the vehicular ADAS determines actuation commands to control the longitudinal motion of the equipped vehicle and alters certain aspects of the longitudinal motion control of the equipped vehicle, such as acceleration and deceleration rates or following distances of other vehicles, by first adjusting the velocity profile based on the traffic light effect and then controlling acceleration based on the adjusted velocity profile.

As discussed above, the vehicular ADAS may control a velocity profile (e.g., longitudinal control) of the equipped vehicle according to a velocity profile defined by a driver of the equipped vehicle. For example, the driver may define a desired gap that the equipped vehicle maintains when traveling behind other vehicles. Moreover, the driver may define a maximum acceleration or deceleration rate for the system to maintain as an in-vehicle comfort metric. For example, a smooth or relaxed in-vehicle comfort metric may define lower maximum acceleration or deceleration rates than an aggressive or fast in-vehicle comfort metric. This user-configurable in-vehicle comfort metric establishes a baseline velocity profile. The adjustments made by the vehicular driving assist system based on the status of the traffic indicator are modifications to this baseline profile. For instance, the system may temporarily increase the maximum acceleration above the “relaxed” baseline in response to a green light, but may still keep it below the maximum defined by the “aggressive” setting, thereby adapting to the situation while respecting the user's general preference.

To that end, responsive to processing sensor data captured by the sensor (e.g., imaging sensor, radar sensor, and/or lidar sensor), the vehicular ADAS may detect or determine an object (i.e., another vehicle) within a predicted path of travel of the equipped vehicle and a status of a traffic indicator. For example, the vehicular ADAS may detect or determine another vehicle (i.e., a leading vehicle traveling along the same traffic lane as the equipped vehicle) is slowing down for a traffic light that recently changed from a green status to a yellow status or from a yellow status to a red status, another vehicle stopped at a red traffic light, and/or another vehicle that is accelerating for a traffic light that recently changed from a red status to a green status. Based on the additional information of the status of the traffic light indicator, the vehicular ADAS may make more informed decisions about the future velocity of other vehicles around the equipped vehicle. For example, responsive to determining a red light status of the traffic indicator, the system predicts a vehicle approaching a red traffic light will likely start to slow down. Conversely, responsive to determining a transition from the red light status to the green light status of the traffic indicator, the system predicts a vehicle stopped at a traffic light that transitioned from red to green will likely start to accelerate. A vehicle that moves at a red stop light is likely only moving forward a short distance, etc. Thus, the vehicular ADAS estimates or predicts or determines a forward movement and/or future velocity of vehicles (e.g., the loading vehicle) based on the current status or a future status of the traffic indicator. The estimation or prediction of the movement or future velocity of the vehicles may further be based on the current velocity, acceleration, and/or deceleration of the vehicles.

Because the predicted movement or future velocity of the vehicles is more informed because of the status of the traffic indicator, the vehicular ADAS may adjust the velocity profile defined by the driver of the equipped vehicle. The velocity profile may include one or more parameters that dictate the vehicle's longitudinal behavior, such as an acceleration profile, a deceleration profile, and a desired gap to be maintained between the equipped vehicle and the leading vehicle. For example, the velocity profile may define a predetermined distance from another stopped vehicle when the equipped vehicle starts to decelerate. Here, the vehicular ADAS may adjust deceleration profile by increasing the predetermined distance (e.g., increase the predetermined distance) when the other vehicle is stopped at a red traffic light because the vehicular ADAS is informed that the other vehicle will not accelerate until the red traffic light turns green. In another example, the velocity profile may define a predetermined or maximum acceleration rate for the equipped vehicle when another vehicle ahead of the equipped vehicle starts to move from a stopped position. Here, the vehicular ADAS may adjust the velocity profile by increasing the maximum or predetermined acceleration rate when the traffic light transitions from red to green because the vehicular ADAS predicts that the other vehicle will not stop or slow down shortly after the traffic light turns from red to green. Thus, the vehicular driving assist system controls acceleration of the equipped vehicle based on the adjusted velocity profile, enabling more context-aware and efficient vehicle operation.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
at least one sensor disposed at a vehicle equipped with the vehicular driving assist system, the at least one sensor sensing exterior of the equipped vehicle;
wherein the at least one sensor at least comprises a forward-viewing camera that views at least forward of the equipped vehicle;
wherein the at least one sensor is operable to capture sensor data;
an electronic control unit (ECU) comprising electronic circuitry and associated software;
wherein the sensor data captured by the at least one sensor is transferred to the ECU;
wherein the electronic circuitry of the ECU comprises a data processor for processing sensor data captured by the at least one sensor and transferred to the ECU;
wherein the vehicular driving assist system, based at least in part on processing at the ECU of sensor data captured by the at least one sensor, (i) determines a leading vehicle in front of the equipped vehicle and within a traffic lane along which the equipped vehicle is currently traveling and (ii) determines status of a traffic indicator for the traffic lane along which the equipped vehicle is currently traveling;
wherein the vehicular driving assist system predicts forward movement of the leading vehicle based at least in part on the status of the traffic indicator; and
wherein the vehicular driving assist system controls acceleration of the equipped vehicle based at least in part on the predicted forward movement of the leading vehicle.

2. The vehicular driving assist system of claim 1, wherein the vehicular driving assist system controls acceleration of the equipped vehicle using a velocity profile, wherein the velocity profile comprises at least one selected from the group consisting of (i) an acceleration profile, (ii) a deceleration profile and (iii) desired gap between the equipped vehicle and the leading vehicle.

3. The vehicular driving assist system of claim 2, wherein the velocity profile is based on a user configurable in-vehicle comfort metric.

4. The vehicular driving assist system of claim 1, wherein the status of the traffic indicator comprises at least one selected from the group consisting of (i) a green light status of the traffic indicator, (ii) a yellow light status of the traffic indicator and (iii) a red light status of the traffic indicator.

5. The vehicular driving assist system of claim 4, wherein the vehicular driving assist system, responsive to determining the red light status of the traffic indicator, predicts forward movement of the leading vehicle will be representative of less than or equal to a current velocity of the leading vehicle.

6. The vehicular driving assist system of claim 4, wherein the vehicular driving assist system, responsive to determining a transition from the green light status to the red light status of the traffic indicator, predicts forward movement of the leading vehicle will be representative of less than a current velocity of the leading vehicle.

7. The vehicular driving assist system of claim 4, wherein the vehicular driving assist system, responsive to determining a transition from the red light status to the green light status of the traffic indicator, predicts forward movement of the leading vehicle will be representative of greater than a current velocity of the leading vehicle.

8. The vehicular driving assist system of claim 1, wherein the vehicular driving assist system comprises an automated cruise control (ACC) system.

9. The vehicular driving assist system of claim 1, wherein the at least one sensor further comprises at least one selected from the group consisting of (i) a forward-sensing lidar sensor and (ii) a forward-sensing radar sensor.

10. The vehicular driving assist system of claim 1, wherein the vehicular driving assist system, responsive to processing at the ECU of image data captured by the forward-viewing camera, determines the status of the traffic indicator for the traffic lane along which the equipped vehicle is currently traveling, and wherein the vehicular driving assist system, responsive to processing at the ECU of sensor data captured by another sensor of the at least one sensor, determines the leading vehicle in front of the equipped vehicle and within the traffic lane along which the equipped vehicle is currently traveling.

11. The vehicular driving assist system of claim 10, wherein the other sensor comprises at least one selected from the group consisting of (i) a forward-sensing lidar sensor and (ii) a forward-sensing radar sensor.

12. The vehicular driving assist system of claim 1, wherein the traffic indicator comprises a traffic light.

13. The vehicular driving assist system of claim 1, wherein the vehicular driving assist system receives a communication indicating a future status of the traffic indicator, and wherein the vehicular driving assist system controls acceleration of the equipped vehicle further based in part on the future status of the traffic indicator.

14. A vehicular driving assist system, the vehicular driving assist system comprising:
at least one sensor disposed at a vehicle equipped with the vehicular driving assist system, the at least one sensor sensing exterior of the equipped vehicle;
wherein the at least one sensor at least comprises a forward-viewing camera that views at least forward of the equipped vehicle;
wherein the at least one sensor is operable to capture sensor data;
an electronic control unit (ECU) comprising electronic circuitry and associated software;
wherein the sensor data captured by the at least one sensor is transferred to the ECU;
wherein the electronic circuitry of the ECU comprises a data processor for processing sensor data captured by the at least one sensor and transferred to the ECU;
wherein the vehicular driving assist system, based at least in part on processing at the ECU of sensor data captured by the at least one sensor, (i) determines a leading vehicle in front of the equipped vehicle and within a traffic lane along which the equipped vehicle is currently traveling and (ii) determines status of a traffic light for the traffic lane along which the equipped vehicle is currently traveling;
wherein the vehicular driving assist system predicts forward movement of the leading vehicle based at least in part on the status of the traffic light;
wherein the vehicular driving assist system, responsive to predicting forward movement of the leading vehicle, adjusts a velocity profile of the equipped vehicle, and wherein the velocity profile defines a maximum acceleration of the equipped vehicle; and
wherein the vehicular driving assist system controls acceleration of the equipped vehicle based on the adjusted velocity profile.

15. The vehicular driving assist system of claim 14, wherein the velocity profile comprises at least one selected from the group consisting of (i) an acceleration profile, (ii) a deceleration profile and (iii) desired gap between the equipped vehicle and the leading vehicle.

16. The vehicular driving assist system of claim 14, wherein the velocity profile is based on a user configurable in-vehicle comfort metric.

17. The vehicular driving assist system of claim 14, wherein the status of the traffic light comprises at least one selected from the group consisting of (i) a green light status of the traffic light, (ii) a yellow light status of the traffic light and (iii) a red light status of the traffic light.

18. A vehicular driving assist system, the vehicular driving assist system comprising:
at least one sensor disposed at a vehicle equipped with the vehicular driving assist system, the at least one sensor sensing exterior of the equipped vehicle;
wherein the at least one sensor at least comprises a forward-viewing camera that views at least forward of the equipped vehicle;
wherein the at least one sensor is operable to capture sensor data;
an electronic control unit (ECU) comprising electronic circuitry and associated software;
wherein the sensor data captured by the at least one sensor is transferred to the ECU;
wherein the electronic circuitry of the ECU comprises a data processor for processing sensor data captured by the at least one sensor and transferred to the ECU;
wherein the vehicular driving assist system, based at least in part on processing at the ECU of sensor data captured by the at least one sensor, (i) determines a leading vehicle in front of the equipped vehicle and within a traffic lane along which the equipped vehicle is currently traveling and (ii) determines status of a traffic indicator for the traffic lane along which the equipped vehicle is currently traveling;
wherein the vehicular driving assist system predicts forward movement of the leading vehicle based at least in part on the status of the traffic indicator;
wherein the vehicular driving assist system, responsive to predicting forward movement of the leading vehicle, adjusts a velocity profile of the equipped vehicle, and wherein the velocity profile defines a maximum acceleration of the equipped vehicle;
wherein the vehicular driving assist system controls acceleration of the equipped vehicle based on the adjusted velocity profile; and
wherein the vehicular driving assist system receives a communication indicating a future status of the traffic indicator, and wherein the vehicular driving assist system adjusts the velocity profile further based in part on the future status of the traffic indicator.

19. The vehicular driving assist system of claim 18, wherein the status of the traffic indicator comprises at least one selected from the group consisting of (i) a green light status of the traffic indicator, (ii) a yellow light status of the traffic indicator and (iii) a red light status of the traffic indicator.

20. The vehicular driving assist system of claim 19, wherein the vehicular driving assist system, responsive to determining the red light status of the traffic indicator, predicts forward movement of the leading vehicle will be representative of less than or equal to a current velocity of the leading vehicle.

21. The vehicular driving assist system of claim 19, wherein the vehicular driving assist system, responsive to determining a transition from the green light status to the red light status of the traffic indicator, predicts forward movement of the leading vehicle will be representative of less than a current velocity of the leading vehicle.

22. The vehicular driving assist system of claim 19, wherein the vehicular driving assist system, responsive to determining a transition from the red light status to the green light status of the traffic indicator, predicts forward movement of the leading vehicle will be representative of greater than a current velocity of the leading vehicle.
